(19) United States
(12) Patent Application Publication
(10) Pub. No.: US 2022/0252519 A1
(43) Pub. Date: Aug. 11, 2022

(54) MICROFLUIDIC DEVICE COMPRISING A MICRODROP HAVING A SOL-GEL MATRIX

(71) Applicants: COMMISSARIAT A L'ENERGIE ATOMIQUE ET AUX ENERGIES ALTERNATIVES, PARIS (FR); ECOLE POLYTECHNIQUE, PALAISEAU (FR); CENTRE NATIONALE DE LA RECHERCHE SCIENTIFIQUE, PARIS CEDEX 16 (FR)

(72) Inventors: Laurent MUGHERLI, GIF CEDEX (FR); Charles BAROUD, PALAISEAU CEDEX (FR); Raphael TOMASl, PALAISEAU CEDEX (FR)

(21) Appl. No.: 17/624,793

(22) PCT Filed: Jul. 3, 2020
(86) PCT No.: PCT/EP2020/068855

§ 371 Date: Jan. 4, 2022

(30) Foreign Application Priority Data
Jul. 5, 2019 (FR) FR1907513

(51) Int. Cl. G01N 21/80; B01L 3/00

(52) U.S. Cl. CPC G01N 21/80; B01L 3/502715; G01N 2021/7773; B01L 2200/0668; B01L 2300/0654; B01L 3/502784

(57) ABSTRACT

A microfluidic device that includes at least one capillary trap and at least one microdrop having a sol-gel matrix. The microdrop is trapped in the capillary trap.

The present invention relates to a microfluidic device including a microdrop having a sol-gel matrix trapped in a capillary trap of the device. The invention also relates to a process for manufacturing such a device. Finally, the invention relates to a process for detecting and/or trapping one or more analytes and to a process for evaluating a sol-gel matrix with such a microfluidic device.

### PRIOR ART

It is known practice from Chokkalingam V., Weidenhof B., Krämer M., Maier W., Herminghaus S., Seemann R (2013). “Optimized droplet-based microfluidics scheme for sol-gel reactions Lab Chip 2013” to form microdrops of microporous silica via a sol-gel process using sol microdrops formed in a microfluidic device. The gel formation and syneresis take place outside the microfluidic device, in a Teflon tube and then in a beaker.

International patent application WO 2011/039475 discloses a microfluidic device including a trapping zone in which one or more microdrops are trapped.

Patent applications FR 2 952 436, FR3 069 534, FR 3 031 592, WO 2012/080665, FR 3 053 602 and WO 2005/100371 also disclose sol-gel materials including a molecular sensor suitable for a particular target analyte.

There is a need for a microfluidic device which enables precise control of the formation of a sol-gel matrix in order to perform easy, rapid, reproducible, homogeneous, reliable and low-cost analyses.

### DESCRIPTION OF THE INVENTION

To this end, the invention proposes, according to a first of its aspects, a microfluidic device including:
at least one capillary trap, and
at least one microdrop including a sol-gel matrix, the microdrop being trapped in the capillary trap.

The term “microfluidic device” refers to a set of microchannels and/or microchambers that are connected together, the sections of which include at least dimension measured in a straight line from one edge to an opposite edge of less than a millimeter.

The term “capillary trap” means a spatial zone of the microfluidic device enabling the temporary or permanent immobilization of one or more microdrops circulating in the microfluidic device.

The term “microdrop” means a drop or a bead having a volume of less than or equal to 1 μL, better still less than or equal to 50 nL and even better still less than or equal to 40 nL.

The term “sol-gel matrix” means a matrix obtained via a sol-gel process. This process may notably be performed using, as precursors, alkoxides of formula M(OR)ₙ or R′-M(OR)ₙ₋₁ or sodium silicates, M being a metal, a transition metal or a metalloid, notably silicon, and R or R′ being alkyl groups, n being the oxidation state of the metal. In the presence of water, hydrolysis of the alkoxy (OR) groups takes place, forming small particles generally less than 1 nanometer in size. These particles aggregate together and form lumps which remain in suspension without precipitating, forming what is known as the sol. The increase of the lumps and their condensation increases the viscosity of the medium and forms what is known as the gel. The gel can then continue to evolve during an aging phase in which the polymer network present within the gel becomes densified. The gel then shrinks, evacuating the solvent out of the formed polymer network, during a step known as syneresis. The solvent then evaporates off, during a step known as drying, which leads to a solid material of porous glass type. The syneresis and drying steps may be concomitant.

The sol-gel matrix of the microdrop may be in gel or solid form after the syneresis and/or drying step of the sol-gel process; the sol-gel matrix is notably a porous solid, for example a xerogel. Preferably, the sol-gel matrix has a form before, during or after the syneresis step and before, during or after the drying step depending on the state of progress of the sol-gel process in the microfluidic device. Preferably, the sol-gel matrix of the or of each microdrop is in solid form after the syneresis and drying step in the microfluidic device, notably in porous form, for example a xerogel.

Preferably, the microdrop has a structure defined by the sol-gel matrix. The microdrop may thus have the properties of a gel or of a solid, preferably a porous solid, for example a xerogel.

Such a microfluidic device makes it possible to have a microdrop immobilized in the capillary trap, thus enabling precise control of the aging and/or of the syneresis and drying of the sol-gel matrix on small, readily controllable samples. This enables precise study of the sol-gel processes involved.

Moreover, by pre-doping the microdrop with one or more molecular sensors, the detection of one or more analytes in gas or liquid phase by the microdrop is possible. This enables direct, rapid detection, occupying a small volume and requiring only a small amount of sol-gel material and of molecular sensors.

Preferably, the microfluidic device includes a plurality of spaced-apart capillary traps and a plurality of microdrops each including a sol-gel matrix, the microdrops each being trapped in one of the capillary traps. The number of capillary traps may be greater than or equal to 10, better still greater than or equal to 100, preferably between 100 and 1000. Preferably, the capillary traps are spaced apart from each other. Preferably, the capillary traps are arranged in a matrix in the microfluidic device. Preferably, the capillary traps are all spaced apart by the same constant distance. Having a matrix of capillary traps each receiving one or more microdrops makes it possible to perform studies or measurements with a large amount of data on a small volume. It is then possible to make observations or statistical measurements to limit the reproducibility and/or homogeneity problems and/or multiplexing of the observations or measurements on the various microdrops in a manner that is quick and easy for the user and on small volumes. Such a device allows rapid, reproducible, homogeneous, reliable and low-cost observations or measurements.

Preferably, the microfluidic device includes a channel having a trapping chamber, the trapping chamber including the capillary trap(s). Preferably, the trapping chamber is delimited by four side walls, an upper wall and a lower wall, the capillary trap(s) extending on the upper wall and/or the lower wall of the trapping chamber.

Preferably, the microfluidic device includes at least one fluid inlet channel and at least one fluid outlet channel in the microfluidic device, notably the trapping chamber. The microfluidic device, notably the trapping chamber, is preferably closed to the liquid with the exception of the inlet channel and the outlet channel Preferably, the inlet channel emerges from a first side of the trapping chamber relative to the capillary trap(s) and the outlet channel extends from a second side of the trapping chamber opposite the first side relative to the capillary trap(s). Such channels allow precise control of the circulation of the fluids in the microfluidic device, and notably make it possible to bring a fluid into contact with the microdrop(s) trapped in the capillary trap(s) by making it flow from the inlet channel to the outlet channel.

The trapping chamber may include a step on the first or the second side of the trapping chamber having a height, measured between the upper and lower walls, greater than that of the rest of the trapping chamber, capillary trap(s) excluded. Such a step allows the formation of a liquid front on one side of the capillary trap(s) so as notably to be able to expose said traps to a gradient of gas coming from the liquid front by vaporization of said liquid or of one of the compounds contained therein.

The microfluidic device, notably the trapping chamber, may include at least one wall made of a porous material, notably made of PDMS, which is at least partially gas-permeable. Such a porous wall allows the evaporation of the solvent during the syneresis step. The rate of the syneresis step and/or of the drying step may be controlled by the porosity of the porous material and/or by controlling a gas stream between the inlet channel and the outlet channel.

As a variant, the microfluidic device consists of one or more nonporous materials, notably made of glass or of a thermoplastic material, for example a cyclic olefin polymer (COP), a cyclic olefin copolymer (COC), polycarbonate or a molded plastic. In this case, the syneresis and/or drying step may take place by subjecting the microdrop to a fluid stream between the inlet channel and the outlet channel. Controlling the speed of the fluid stream allows precise control of the syneresis and/or drying.

Preferably, the capillary trap(s) each form a cavity in a wall of the microfluidic device, notably of the trapping chamber.

Preferably, the height of the cavity, corresponding to the distance between the base of the cavity and the opposite wall of the microfluidic device, is greater than or equal to twice the height of the microfluidic device at the edge of the capillary trap, corresponding to the distance between the wall in which the cavity is formed and the opposite wall at the edge of the capillary trap.

Preferably, the smallest width of the cavity is greater than or equal to twice the height of the microfluidic device at the edge of the capillary trap(s).

Preferably, the height of the microfluidic device at the edge of the capillary trap(s) is less than or equal to the smallest dimension of the or of each trapped microdrop including a sol-gel matrix, notably less than or equal to the smallest dimension of the or of each trapped microdrop after syneresis. In this way, the or each microdrop cannot come out of the capillary trap without the microfluidic device being destroyed. This enables permanent precise localization of the microdrops, thus facilitating their observations at any moment.

Such dimensions of the cavity also allow the microdrop(s) to be formed directly in the capillary trap(s) by breaking a liquid forming the sol or a part of the sol, as is detailed hereinbelow in relation with the process for manufacturing the microfluidic device.

At least one capillary trap can include a first trapping zone in which the microdrop(s) including a sol-gel matrix is trapped and at least one second trapping zone having a force of trapping of a given microdrop which is different from that of the first trapping zone to trap a different microdrop. Such capillary traps are notably described in the international patent application WO 2018/060471 incorporated herein by reference.

At least one capillary trap may have a single trapping zone configured to trap a single microdrop, the microdrop including a sol-gel matrix, or a plurality of microdrops, at least one of the microdrops including a sol-gel matrix.

Preferably, the sol-gel matrix/matrices are obtained via a hydrolytic sol-gel process.

Preferably, the sol-gel matrix/matrices are obtained from precursors chosen from alkoxides, notably zirconium alkoxides, notably zirconium butoxide (ZTBO), zirconium propoxide (ZTPO), titanium, niobium, vanadium, yttrium, cerium, aluminum or silicon alkoxides, notably tetramethoxysilane (TMOS), tetraethoxysilane (TEOS), tetrapropoxysilane (TPOS), tetrabutoxysilane (TB OS), trimethoxysilane, notably methyltrimethoxysilane (MTMOS), propyltrimethoxysilane (PTMOS) and ethyltrimethoxysilane (ETMOS), triethoxysilanes, notably methyltriethoxysilane (MTEOS), ethyltriethoxysilane (ETEOS), propyltriethoxysilane (PTEOS) and aminopropyltriethoxysilane (APTES), and mixtures thereof.

The microdrop(s) may include a solvent, notably a solvent chosen from water, methanol, ethanol, propanol, butanol, 2-methoxyethanol, acetone, DMSO, DMF, NMF, formamide, methyl ethyl ketone, chloroform, dichloromethane, acetic acid and mixtures thereof, preferably a mixture of water and butanol.

The microdrop(s) may include other additives, notably one or more catalysts, notably chosen from acetic acid, nitric acid, sulfuric acid, hydrofluoric acid and ammonium hydroxide, and/or one or more stabilizers, notably chosen from acetic acid, acetylacetone, glycols, methoxyethanol, glycols and β-keto esters.

The microdrop(s) may be translucent, preferably transparent.

The device may include a single microdrop including a sol-gel matrix in the or in each capillary trap.

As a variant, the device includes a plurality of microdrops including a sol-gel matrix in the or in each capillary trap. The microdrops including a sol-gel matrix may be arranged in the capillary trap as a column.

Preferably, the device includes a plurality of microdrops including a sol-gel matrix which are trapped in the capillary trap(s) of the microfluidic device.

The microdrops may be substantially identical, and may notably have substantially identical compositions. In the case of a microfluidic device containing several capillary traps, this notably makes it possible to perform statistical studies with a single microfluidic device. This limits the reproducibility and/or homogeneity problems and also the edge effects.

As a variant, at least some microdrops are different, and notably have different compositions or structures. In the case of a microfluidic device containing several capillary traps, this notably makes it possible to perform multiplexing with a single microfluidic device on small volumes.

The microdrops may all include the same sol-gel material of which the sol-gel matrix is composed. This may enable studies to be performed on a particular sol-gel material.

The microdrops may include sol-gel matrices of identical compositions. This may enable statistical studies to be performed on the structure of the sol-gel matrix or enable easy formation of the microdrops from the same initial solution under the same conditions.

As a variant, at least two microdrops include different sol-gel matrices, notably matrices having different structures or compositions. This may enable different sol-gel matrices to be studied on the same microfluidic device and enable multiplexing of the sol-gel matrices.

The microdrop(s) including a sol-gel matrix may each include one or more molecular sensors. Each molecular sensor preferably includes one or more identical detection units which are each capable of reacting in the presence of a target analyte to induce an observable change and which comprise one or more molecules. The molecular sensors are preferably incorporated into the sol-gel matrix to detect, in each of the corresponding capillary traps, the presence of one or more particular target analytes. Preferably, the molecular sensor(s) are distributed in each microdrop within the sol-gel matrix. Preferably, the or each molecular sensor is configured to have an optical property, notably a color, an absorbance, a reflectance, a fluorescence or a luminescence, which is different in the presence of the target analyte, notably by reaction or bonding therewith. It is then possible with the microfluidic device to analyze the presence of one or more target analytes in a liquid or gaseous fluid, by placing it in contact with the microdrops in the microfluidic system. It is also possible to capture the target analytes of the fluid to be tested using molecular sensors in the case where a bond forms with the target analyte. Effecting detection by a change in optical property makes visual detection or detection by a simple optical device easy and direct.

The microdrop(s) may include at least two molecular sensors for detecting different target analytes.

At least one microdrop may include at least two molecular sensors configured to detect for the presence of different target analytes, the molecular sensors preferably having different optical properties from each other in the presence of the corresponding target analytes. Preferably, the molecular sensors have reactions with their corresponding target analytes that are independent from each other. This enables simple detection of different analytes in parallel in the same microdrop. For example, the color of each microdrop makes it possible to determine the relative concentrations of the target analytes between themselves and the concentration of each of the analytes.

Preferably, at least two microdrops include molecular sensors for detecting different target analytes. This enables the detection in parallel of target analytes by different microdrops, notably in the case of molecular sensors having a similar response to the presence of the corresponding target analyte. Such a device is easy to use and enables easy and immediate analysis of the presence or absence of different target analytes.

At least two microdrops may include molecular sensors having the same detection unit in different concentrations. Preferably, several microdrops may include molecular sensors having the same detection unit in different concentrations in pairs. The microdrops may be arranged in a plurality of capillary traps or in the same capillary trap, to form a concentration gradient of the detection unit between the inlet channel and the outlet channel.

The molecular sensor(s) may include a detection unit chosen from 4-amino-3-penten-2-one, p-dimethylaminobenzaldehyde, p-dimethylaminocinnamaldehyde, p-methoxybenzaldehyde, 4-methoxynaphthaldehyde, crotonic acid, p-diazobenzenesulfonic acid, 4-aminoantipyrine, carmine indigo, a quinone compound, a mixture of iodide and of a compound chosen from starch, amylose, amylopectin, xyloglucan, xylan, chitosan, glycogen, polyvinyl alcohol or a polyvinyl alcohol compound, cellulose or a cellulose compound, α-cyclodextrin, theobromine or block polymers of polypropylene oxide and polyethylene oxide, a mixture including a phenol and sodium nitroprusside, and the compound as described in patent application WO 2005/100371 which is incorporated herein by reference. The molecular sensor(s) may include one or more additives, notably chosen from solvents, acids and bases, oxidizing agents and reducing agents for promoting the reactions with the target analytes, and/or one or more additional molecules enabling, alone or combined with others, a more or less selective interaction with the target analyte, and/or a particular chemical function, notably giving a particular coloring, reacting by a color change to the pH, or giving a particular fluorescence.

Preferably, the molecular sensor(s) consist of the identical detection unit(s) and optionally of one or more additives. The molecular sensor(s) may each make it possible to detect a target analyte chosen from volatile organic compounds, notably those defined in the lists of priority pollutants from ANSES (Agence Nationale de Sécurité Sanitaire de l'alimentation de l'environnement et du travail), notably aldehydes, such as formaldehyde, acetaldehyde or hexaldehyde, carbon monoxide and/or carbon dioxide, dioxygen, hydrogen, phenol and derivatives thereof, indole compounds, notably indole, scatole or tryptophan, chloramines, nitrogen dioxide, ozone, halogenated compounds, notably boron trifluoride, derivatives thereof and boron trichloride, aromatic hydrocarbons, such as naphthalene, benzene and toluene and nonaromatic hydrocarbons, such as pentane, hexane and heptane, acrolein, nitrogen dioxide and ethylbenzene.

Preferably, the microfluidic device includes a plurality of spaced-apart capillary traps, each including a microdrop including a sol-gel matrix, notably made of a material that is solid after syneresis, and one or more molecular sensors in each sol-gel matrix. In the case where the sol-gel matrix is a solid matrix obtained after syneresis, the microfluidic device in its given form is particularly stable. It may thus be prepared in advance of its use, for example in the laboratory, and then stored, and may be used subsequently, notably directly in the field.

The or several microdrops may include observable, notably fluorescent, microbeads in the sol-gel matrix. Such microbeads can enable evaluation of the gel time during the formation of the sol-gel matrix.

The device may include a system for controlling the temperature of the microfluidic device enabling the microfluidic device to be cooled or heated notably to control the formation of the sol-gel matrix via the sol-gel process.

Preferably, the device includes a system for circulation, notably from the inlet channel to the outlet channel, of the fluids in the microfluidic device, notably a pump, a syringe pump or a pressure differential.

According to a second of its aspects, a subject of the invention is also a process for manufacturing a microfluidic device, notably the microfluidic device as described previously, the process including the trapping of at least one microdrop including a sol in a capillary trap of the microfluidic device and the formation of a sol-gel matrix in the trapped microdrop using the sol via a sol-gel process.

Such a process allows the formation of a microdrop containing a sol-gel matrix directly in the capillary trap precisely located in the microfluidic device. The fact that the sol-gel matrix forms in the capillary trap enables precise and reproducible control of its formation. Furthermore, the small volumes involved facilitate the homogeneity and speed of the formation.

The fact that the microdrop is trapped in a capillary trap also allows precise knowledge of its location in the microfluidic device, facilitating its analysis or its use for the purpose notably of detecting target analytes when it includes one or more molecular sensors.

Preferably, the process includes the trapping of a plurality of microdrops including a sol in one or more capillary traps of the microfluidic device, notably of the trapping chamber, and the formation of a sol-gel matrix in each microdrop using the sol via a sol-gel process.

Preferably, the process includes the trapping of at least one microdrop, notably of a single microdrop, including a sol in each capillary trap of a microfluidic chip including a plurality of spaced-apart capillary traps and the formation of a sol-gel matrix in each microdrop using the sol via a sol-gel process. The fact that one or more microdrops are trapped in several capillary traps makes it possible to form a matrix of spatially localized microdrops in the microfluidic device, making it possible to perform statistical analyses and/or multiplexing depending on the composition of the microdrops.

As a variant, the process includes the trapping of a plurality of microdrops including a sol-gel matrix in a capillary trap of the microfluidic device, the device including one or more capillary traps which can trap a plurality of microdrops, and the formation of a sol-gel matrix in each microdrop using the sol via a sol-gel process. In this case, the capillary trap may contain, for example, microdrops arranged in a column and including a sol.

Preferably, the process includes the addition of one or more molecular sensors and/or microbeads that are observable in the microdrop(s) before or after formation of the sol-gel matrix, preferably before the syneresis step, each molecular sensor enabling the detection of at least one target analyte. The molecular sensor(s) may be as described previously in relation with the microfluidic device.

The addition of one or more molecular sensors and/or microbeads that are observable may take place in the microdrop(s) including a sol after the trapping of the microdrop(s) including a sol. The process may include the addition of additional microdrops including the molecular sensor(s) and/or the microbeads that are observable in the microfluidic device, the trapping of one or more additional microdrops in the or each capillary trap and the coalescence of the additional microdrop(s) and of the microdrop including the sol or the sol-gel matrix. In this case, each capillary trap preferably traps only one microdrop including a sol during the trapping. The addition of one or more microdrops may take place according to the process described in patent application FR 3 056 927 using a capillary trap including different trapping zones having different trapping forces.

As a variant, the addition of molecular sensors and/or of microbeads that are observable to the sol may take place prior to the trapping of the microdrops, notably during a prior step of formation of the microdrops or directly in the sol before the formation of the microdrops.

The trapping of one or more microdrops each including a sol in the capillary trap(s) may include:

(i) the trapping of a first microdrop including a portion of the sol in the or each capillary trap,

(ii) n successive additions of one or more complementary microdrops including another portion of the sol to the microfluidic device, notably water, to trap it (them) in the or each capillary trap, n being an integer preferably between 1 and 10, and the coalescence of the first microdrop and of the complementary microdrop(s) in each capillary trap to obtain the sol, the coalescence taking place after each successive addition or after all of the successive additions,

(iii) optionally the addition of additional microdrops including one or more molecular sensors and/or microbeads that are observable to the microfluidic device, the trapping of said additional microdrop(s) in the capillary trap(s) and the coalescence of the additional microdrops and of the microdrop in the or each capillary trap, step (iii) taking place before or after step (ii).

The coalescence of the additional microdrops may take place at the same time as the coalescence of the complementary microdrops. The additional microdrops may be identical or different.

Preferably, the trapping of one or more microdrops each including a sol in the capillary trap(s) may include:

(i) the trapping of a first microdrop including a portion of the sol in the or each capillary trap,

(ii) optionally the addition of additional microdrops including one or more molecular sensors and/or microbeads to the microfluidic device, the trapping of said additional microdrop(s) in the capillary trap(s) and the coalescence of the additional microdrops and of the first microdrops in the or each capillary trap to form the first doped microdrops,

(iii) the addition of one or more complementary microdrops including the remainder of the sol to the microfluidic device, notably water, to trap it (them) in the or each capillary trap and

(iv) the coalescence of the first doped or undoped microdrop and of the complementary microdrop(s) in each capillary trap to obtain the sol.

Preferably, the trapping of the microdrop(s) including a sol takes place in a carrier fluid surrounding the or each microdrop.

The process may include a prior step of forming the microdrop(s) including the sol or the first microdrop(s) including a portion of the sol before the step of trapping in the capillary traps. The microdrops may be formed in an ancillary microdrop formation system, notably another microfluidic device or directly in the microfluidic device upstream of the capillary traps, notably at the inlet of the trapping chamber. The microdrops are preferably formed and mixed in a carrier fluid that is immiscible with the sol and are entrained in circulation by the carrier fluid in the microfluidic device to be trapped in the capillary trap(s). The formation of the microdrops prior to trapping them enables the trapping of a plurality of microdrops by capillary traps, where appropriate, and/or the trapping of a panel of microdrops that are not all identical, notably in terms of composition.

As a variant, the trapping of the microdrop(s) including the sol or of the first microdrop(s) including a portion of the sol includes:
the filling of the microfluidic device with a first solution including the sol or the sol portion and optionally one or more molecular sensors and/or one or more microbeads in the sol,
the injection of a second solution of a carrier fluid that is immiscible with the sol upstream of the capillary trap(s) to push the first solution toward an outlet of the microfluidic device downstream of the capillary trap(s), the microfluidic device being configured to enable the formation of a microdrop of the first solution in the or each capillary trap during the injection of the second solution into the microfluidic device. Via this trapping process, the microdrops are formed directly in the capillary traps and are trapped therein as soon as they are formed. This makes it possible to dispense with the handling of the microdrops prior to trapping them and the constraints associated with the formation of the microdrops prior to trapping. This also makes it possible to form all of the microdrops simultaneously, which limits the risk of formation of the gel in the microdrop(s) outside the capillary trap. In this trapping process, only one microdrop is formed in each capillary trap and the microdrops formed all have an identical composition since they are formed from the same first solution.

At least two microdrops trapped in one or two different capillary traps, preferably in two different traps, may be different, and may notably include a different sol, notably differing by its nature and/or its concentration of at least one compound of the sol or may include molecular sensors that are different, notably in terms of the concentration of the detection unit or of the nature of the detection unit. This difference may be obtained by:
the trapping of microdrops including the sol or of a first microdrop including a portion of the sol which are different, and/or
the trapping of additional microdrops which are different, notably in terms of a different concentration of one or more molecular sensors or of different molecular sensors or of a different amount of microbeads, and/or
the trapping of a different number of identical or different additional microdrops in the capillary traps, and/or
the formation in the capillary traps of first microdrops including a portion of the sol in the identical capillary traps and the addition of complementary microdrops of different compositions or in different amounts to the capillary traps containing the first microdrops.

Having different microdrops in different capillary traps enables multiplexing of the microfluidic device. It is then possible, on the same microfluidic device, to study the evolution of different sols or to detect different target analytes.

At least two microdrops trapped in one or two different capillary traps, preferably in two different traps, may include an identical sol. It is then possible, on the same microfluidic chip, to statistically study the evolution of the sol, notably its gel time or its diameter.

The microfluidic device may include several capillary traps each trapping a microdrop including a sol, the microdrops being derived from a panel of microdrops having groups of microdrops in which the microdrops are identical, the groups of microdrops including sols that are different from each other.

As a variant, the microfluidic device includes several capillary traps each trapping a microdrop including a sol, the microdrops being derived from a panel of identical microdrops.

Preferably, the volume percentage of alcohol of the sol is less than or equal to 80%. Preferably, the volume percentage of alcohol of the sol is greater than or equal to 20%.

Preferably, the physical properties of the microdrop(s), of the carrier fluid and of the walls of the microfluidic device, the viscosities of the microdrop(s) and of the carrier fluid and the mode of functioning of the device, notably the flow rates of the microdrop(s) and of the carrier fluid in the microfluidic device, are chosen so that the microdrop(s) including a sol are spaced apart from the walls of the microfluidic device, notably separated from said walls by a layer of the carrier fluid. Preferably, the carrier fluid totally surrounds the or each microdrop. Preferably, the carrier fluid is more wetting with the walls of the microfluidic device than the sol of the or each microdrop.

Preferably, the gel time of the sol is greater than or equal to 5 minutes, better still greater than or equal to 10 minutes.

The process may include the circulation of a fluid between the inlet channel and the outlet channel during the trapping of the microdrop(s) including a sol and/or the formation of the sol-gel matrix. Such a circulation of fluid enables the content of the trapped microdrop(s) to be placed in motion so as to homogenize the content of said microdrop(s). This is particularly useful when the sol microdrops are formed by adding one or more complementary and/or additional microdrops and/or during the formation of the sol-gel matrix. This may also make it possible to place microbeads in motion in the sol so as to be able to evaluate the formation of the gel.

The process may include control of the temperature of the microfluidic device, notably lowering of the temperature of the microfluidic device during the trapping of the microdrops and raising of the temperature of the microfluidic device during the formation of the sol-gel matrix. Preferably, the temperature of the microfluidic device during the trapping is between 0 and 30° C., better still between 5 and 15° C. Preferably, the temperature of the microfluidic device during the formation of the sol-gel matrix is between 20 and 80° C., better still between 20 and 60° C., even better still between 30 and 50° C. Controlling the temperature of the device during the process enables precise control of the formation of the sol-gel matrix and makes it possible to have a reproducible device. Lowering the temperature during trapping makes it possible to increase the gel time and to avoid the formation of the sol-gel matrix outside the capillary traps, which might block the microfluidic device. Increasing the temperature during the formation of the sol-gel matrix makes it possible, notably by accelerating the formation of the gel, to control the syneresis and/or drying step.

Preferably, the process includes an additional step of drying of the microfluidic matrix by evaporating off the solvent contained in the microdrop. The drying may include the evaporation of the solvent through a gas-porous surface of the microfluidic device and/or the circulation of a fluid in the microfluidic device between at least one inlet channel upstream of the capillary traps and at least one outlet channel downstream of the capillary traps. The process may include control of the drying rate by controlling the flow of fluid in the microfluidic device and/or by the choice of the pore size.

The process may include a step of evacuating the fluid surrounding the microdrops after the drying step. In the case of a liquid, this evacuation may take place by evaporation of this liquid, through the inlets and outlets of the microchannel or through a porous surface. The evacuation may also be forced, via the injection of another liquid or gas, through the microchannel. In this case, the flow of the liquid or gas replaces the initial liquid.

The process may include real-time visualization of the syneresis and of the drying by means of a device for observing the sol-gel matrix in the or each capillary trap, notably by means of an optical device for forming an image of each microdrop.

According to a third aspect, a subject of the invention is also a process for detecting and/or trapping one or more analytes in a fluid to be tested using the microfluidic device as described previously or the microfluidic device manufactured by means of the process as described previously, the microdrop(s) trapped in the capillary trap(s) each including in the sol-gel matrix one or more molecular sensors configured to detect and/or trap one or more target analytes, the process including the exposure of the microdrop(s) trapped in the microfluidic device to a fluid to be tested and the detection and/or trapping of the target analyte(s) in the fluid to be tested.

Precise localization of the microdrops in the microfluidic device enables direct visualization of the presence of the target analyte(s) in the fluid to be tested. Trapping the target analyte may enable it to be extracted from the fluid to be tested, so as to reduce the concentration of the target analyte in the fluid leaving the microfluidic device and/or to capture the target analytes in the fluid so as to recover them and optionally subsequently use them.

Integrating the microdrops in a microfluidic device and fixing them therein enables them to be readily exposed to the fluid to be tested and enables the detection and/or trapping of the target analytes without it being necessary to handle the microdrops or to modify the device. This also facilitates the analysis of the microdrops.

In the case where the device includes several molecular sensors, it allows the detection and/or trapping in parallel of several target analytes in the fluid to be treated.

Furthermore, in contrast with electronic devices for detecting one or more target analytes, such a device does not require any particular calibration.

Preferably, the molecular sensor(s) are as described previously in relation with the microfluidic device.

Preferably, the fluid to be tested is a liquid or a gas.

Preferably, the process includes the circulation of the fluid in the microfluidic device from an inlet channel of the microfluidic device upstream of the capillary trap(s) to an outlet channel of the microfluidic device downstream of the capillary trap(s) by means of a microfluidic system, notably a pump, a syringe pump or a pressure differential.

Preferably, the presence of the target analyte(s) is detected by a change in an optical property of the or of each molecular sensor, notably the color, the absorbance, the reflectance, the fluorescence or the luminescence of the or each molecular sensor.

Preferably, the fluid is a gas, notably ambient air, and the exposure of the microdrop(s) takes place by circulating the gas between the inlet channel and the outlet channel in the microfluidic device, notably in the trapping chamber. Forced circulation of the gas may be obtained by means of a mass flow rate regulator, a pump, a syringe pump, a pressure differential or an equivalent system. To detect the analyte, the user merely has to inject into the microfluidic device the gas present in the environment in which the detection is to be performed, to check for the presence or absence of the target analyte and/or the concentration thereof and/or to trap it.

When the fluid is a gas, notably ambient air, the exposure of the microdrop(s) may take place through a gas-porous wall of the microfluidic device, notably of the trapping chamber. It then suffices to place the microfluidic device in the environment in which the detection is to be performed in order to check for the presence or absence of the target analyte and/or its concentration and/or to trap the target analytes.

The process may include the introduction of a liquid into the microfluidic device until a liquid front forms in the vicinity of the microdrop(s), notably along a step in the microfluidic device, the microdrop(s) not being in contact with the liquid but with a gas formed by evaporation of the liquid in the microfluidic device from the liquid front.

As a variant, the process includes the introduction of a liquid into the microfluidic device and its circulation between the inlet channel and the outlet channel and the detection, directly in the liquid, of the presence or absence of the target analyte.

Preferably, the process includes the determination of the concentration, to which is exposed the or each microdrop of the microfluidic device, of at least one target analyte in the fluid to be tested, notably via the intensity of the optical property measured, notably a color, fluorescence or luminescence intensity. In this case, the concentration may be determined precisely by referring to preestablished calibration curves.

The process may include the detection of a concentration gradient of one or more target analytes in the fluid to be tested by visualization notably of different detection intensities depending on the position of the microdrop on the microfluidic device.

According to a fourth aspect, a subject of the invention is also a process for evaluating a sol-gel matrix in a microfluidic device as described previously or manufactured by means of the process described previously, the microdrop(s) trapped in the capillary traps including said sol-gel matrix.

The process may include the observation of the formation of the matrix or of the syneresis of the sol-gel matrix in real time, notably the real-time observation of the diameter of the microdrop during the step of formation of the gel, of syneresis and of drying.

The process may include evaluation of the gel time of the sol-gel matrix of the sol in the microdrop during the formation of said matrix in the microdrop, notably to deduce therefrom the gel time of the sol-gel material in macroscopic volumes. The process may include the application of a fluid stream, notably of oil in the microfluidic device to generate a movement of fluid in the or each microdrop and the observation of the movement of observable microbeads, notably of fluorescent microbeads, in the microdrop, the gel time being determined by observation of the immobilization of the microbeads in the gel.

The process may include control of the temperature of the microdrop or of each microdrop.

The invention may be better understood on reading the following description of nonlimiting implementation examples of the invention, with regard to the attached drawing, in which:

### BRIEF DESCRIPTION OF THE DRAWINGS

FIG. 1 schematically depicts an example of a microfluidic device according to the invention,

FIG. 2 is a view in cross section along II-II of the device of FIG. 1,

FIG. 3 is a view in perspective of a variant of the microfluidic device according to the invention,

FIG. 4 is a schematic view along IV of the microfluidic device of FIG. 3,

FIG. 5 is a schematic view in cross section along V-V of the microfluidic device of FIGS. 3 and 4,

FIG. 6A represents one step of a process for manufacturing a device according to the invention,

FIG. 6B represents another step of the process of FIG. 6A,

FIG. 6C represents another step of the process of FIGS. 6A and 6B,

FIG. 7 is a view of a detail of the device obtained via the process illustrated in FIGS. 6A to 6C, after syneresis and drying of the sol-gel matrix,

FIG. 8 is a variant of the device according to the invention,

FIG. 9 is a view in cross section along IX-IX of the device of FIG. 8,

FIG. 10 represents the fluorescence measurement of a detail X of the device of FIG. 4 produced according to example 3,

FIG. 11 is a graph showing the fluorescence intensity of the microdrops of the device of example 3 as a function of time for different groups of microdrops,

FIG. 12 shows images of a microdrop of the device produced according to example 4 at different times during the formation of the gel,

FIG. 13 is a graph representing the gel time measured as a function of the temperature with the device of example 4,

FIG. 14 is a graph representing the difference in gel time calculated between the microfluidic device and a macroscopic device as a function of the temperature with the device of example 4,

FIG. 15 shows images of microdrops of the device produced according to example 4 before and after syneresis,

FIG. 16 is a graph representing the diameter of the microdrops measured as a function of time with the device of example 4,

FIG. 17 is a graph representing the gel time measured as a function of the temperature with the device of example 5, and

FIG. 18 is a graph representing the difference in gel time calculated between the microfluidic device and a macroscopic device as a function of the temperature with the device of example 5.

### DETAILED DESCRIPTION

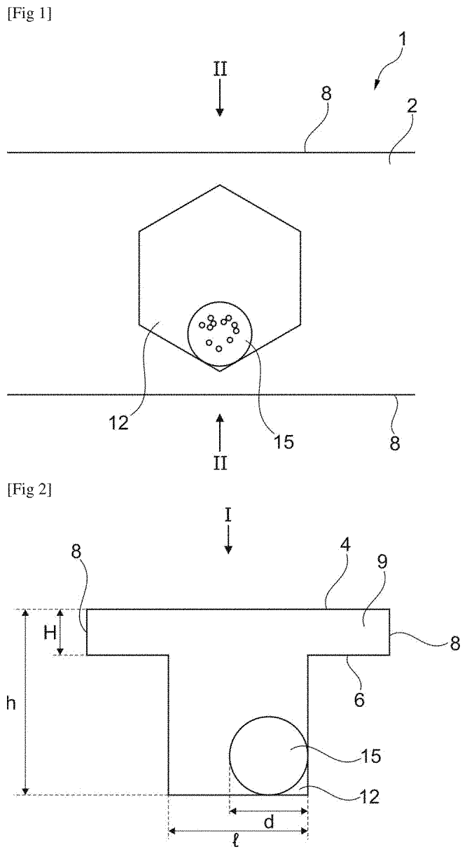

FIG. 1 schematically depicts a first embodiment of a microfluidic device 1 according to the invention.

In the example illustrated in FIG. 1, the device includes a microchannel 2 including a capillary trap 12 in which a microdrop 15 including a sol-gel matrix is trapped. The microchannel 2 has a rectangular cross section and is delimited by an upper wall 4, a lower wall 6 and two side walls 8, as illustrated in FIG. 2.

In the example illustrated in FIGS. 1 and 2, the microdrop 15 is a microbead including the sol-gel matrix in solid form after the syneresis step of the sol-gel process, i.e. the microbead is free of any solvent, said solvent having been evaporated off and the sol-gel matrix having shrunken. The microdrop then has the smallest size that it can take and is undeformable.

The capillary trap 12 is formed by a cavity in the lower wall 6 in which the microdrop is trapped. In the example illustrated in FIG. 2, the cavity is a cavity of the lower wall 6, but it could also be a cavity of the upper wall 4; the microdrop would be trapped in the same way. As shall be seen hereinbelow, the microdrop is trapped in the capillary trapped 12 in liquid form, the matrix notably being in sol form. A liquid microdrop placed in the microchannel 2 and crushed has a large external surface area. This microdrop thus seeks naturally to reduce its external surface area, which brings it to migrate toward the capillary trap 12 having a greater height when it comes into the vicinity of the capillary trap. The capillary trap 12 makes it possible to immobilize one or more microdrops, which makes it possible, for example, to examine them using a microscope and/or to monitor the progress of a reaction within a trap over a long period of time.

In the example illustrated in FIG. 2, the height H of the microchannel 2, defined by the distance between the upper wall 4 and the lower wall 6, at the edge of the capillary trap 12 is less than the smallest dimension d of the microdrop 15 after the syneresis step of the sol-gel process. Thus, the microdrop 15 is definitively trapped in the capillary trap 12.

Preferably, the height h of the capillary trap 12, defined between the base of the capillary trap 12 and the opposite wall of the microchannel 2, is greater than or equal to twice the height H of the microchannel 2 at the edge of the capillary trap 12. Preferably, the width l of the capillary trap 12 is greater than or equal to twice the height H of the microchannel 2 at the edge of the capillary trap 12. These dimensions allow efficient trapping of the microdrop before the gel formation, syneresis and drying steps of the sol-gel process for obtaining the sol-gel matrix.

The height H of the microchannel 2 at the edge of the capillary trap 12 is preferably between 15 μm and 200 μm, better still between 50 μm and 150 μm, for example substantially equal to 100 μm.

The height h of the capillary trap 12 is preferably between 30 μm and 800 μm, better still between 450 μm and 600 μm, for example substantially equal to 520 μm.

In the example illustrated in FIG. 1, the capillary trap 15 has a hexagonal cross section. However, the invention is not limited to such a shape of capillary trap. Said trap may have, for example, a circular or polygonal cross section or may include a main trapping zone and one or more secondary trapping zones as described in patent application WO 2018/060471, incorporated herein by reference.

The sol-gel matrix is preferentially obtained via a hydrolytic sol-gel process.

It is obtained from precursors chosen from alkoxides, notably zirconium alkoxides, notably zirconium butoxide (ZTBO), zirconium propoxide (ZTPO), titanium, niobium, vanadium, yttrium, cerium, aluminum or silicon alkoxides, notably tetramethoxysilane (TMOS), tetraethoxysilane (TEOS), tetrapropoxysilane (TPOS), tetrabutoxysilane (TBOS), trimethoxysilanes, notably methyltrimethoxysilane (MTMOS), propyltrimethoxysilane (PTMOS) and ethyltrimethoxysilane (ETMOS), triethoxysilane, notably methyltriethoxysilane (MTEOS), ethyltriethoxysilane (ETEOS), propyltriethoxysilane (PTEOS) and aminopropyltriethoxysilane (APTES), and mixtures thereof.

The microdrop(s) may include a solvent, notably a solvent chosen from water, methanol, ethanol, propanol, butanol, 2-methoxyethanol, acetone, DMSO, DMF, NMF, formamide, methyl ethyl ketone, chloroform, dichloromethane, acetic acid and mixtures thereof, preferably a mixture of water and butanol.

The microdrop(s) may include other additives, notably catalysts, such as acetic acid, nitric acid, sulfuric acid, hydrofluoric acid and ammonium hydroxide, or stabilizers, such as acetic acid, acetylacetone, glycols, methoxyethanol, glycols and β-keto esters.

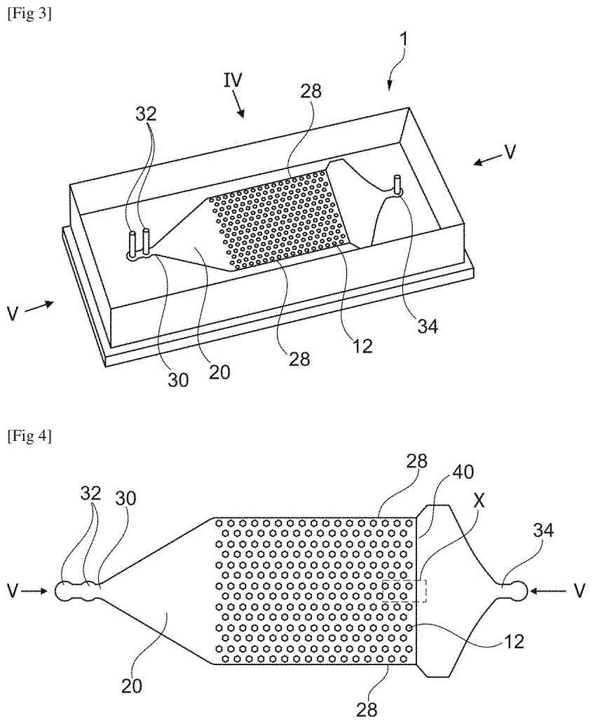

FIGS. 3 and 5 schematically depict a second embodiment of a microfluidic device 1 according to the invention.

In the example illustrated in FIGS. 3 to 5, the device 1 includes a trapping chamber 20 including a plurality of capillary traps 12 ordered as a plurality of rows of traps 12 arranged staggered relative to each other. The trapping chamber 20 is connected upstream of the capillary traps 12 to an inlet microchannel 30 fed with fluid via two fluid feed microchannels 32 and downstream to an outlet microchannel 34. The trapping chamber 20 has a rectangular cross section and is delimited by an upper wall 24 and a lower wall 26, which are notably visible in FIG. 5, and four side walls 28, which are notably visible in FIGS. 3 and 4.

The number of capillary traps is preferably between 10 and 5000, notably between 100 and 500, for example equal to 231.

As may be seen in FIG. 3, the microfluidic device 1 may be formed in a plate of a suitable material, for instance PDMS (polydimethylsiloxane) by use of a common flexible lithography technique, as is known. The microchannels 30 and the trapping chamber 20 may be formed at the surface of the plate, onto which is bonded a glass microscope slide, for example.

The trapping chamber 20 also includes a step 40 downstream of the capillary traps 12, having a height m that is greater than that of the trapping chamber at the edge of the step. Such a step 40 makes it possible, by insertion of a liquid via the outlet channel 34, to form, in the trapping chamber 20, a liquid front downstream of the capillary traps 12, the liquid front being defined by the shape of the step. Specifically, the liquid is maintained by interface tension in the zone of the greatest height. Preferably, the step has a height m of between 80 μm and 250 μm, preferably between 100 μm and 150 μm. Preferably, the step has a height m substantially between 105% and 200%, preferably between 110% and 130%, notably substantially equal to 115% of the height of the trapping chamber 20 at the edge of the step 40.

Each capillary trap 12 is preferably as described previously and can trap a microdrop 15 including a sol-gel matrix.

Preferably, the volume percentage of alcohol of the sol is between 80% and 20%.

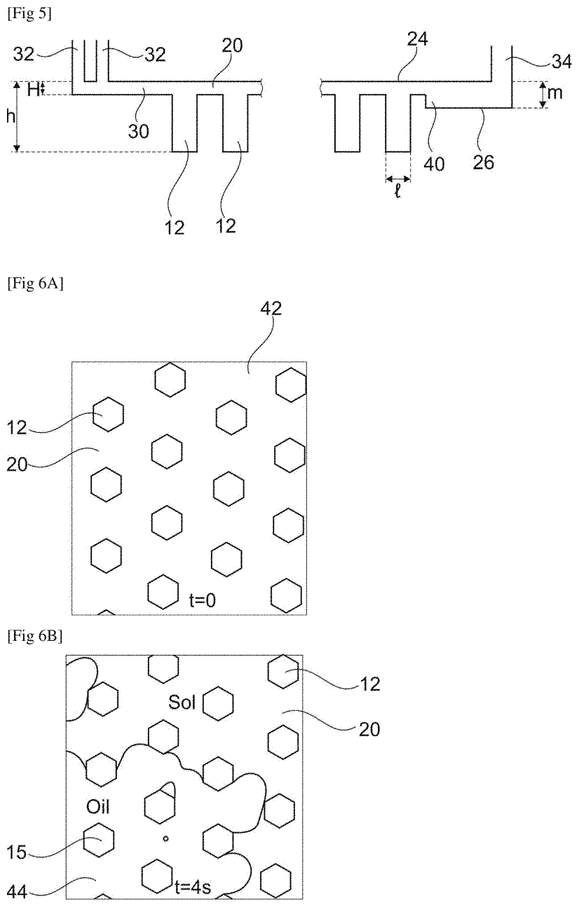

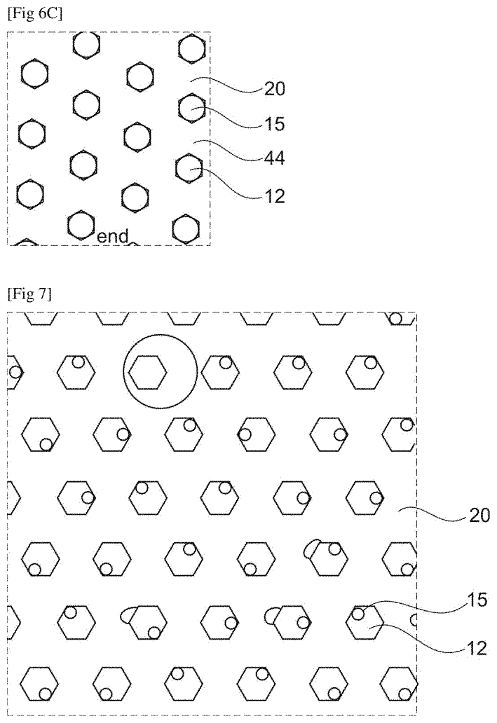

The capillary traps can trap the microdrops via the process illustrated in relation with FIGS. 6A to 6C described below as “breaking of the drops in capillary traps” described, for example, in patent application FR 3 056 927, the content of which is incorporated herein by reference.

During a first step illustrated in FIG. 6A, a first solution 42 including a sol is introduced into the trapping chamber 20 via one of the feed microchannels 32 so as to fill it. During a second step illustrated in FIG. 6B, a second solution 44 including a solvent which is immiscible with the first solution, notably an oil, is introduced into the trapping chamber 20 via one of the feed microchannels 32. The second solution flushes the first solution from the trapping chamber and forms the microdrops of first solution directly in the capillary traps 12 by breaking the first solution in each capillary trap, as may be seen in FIG. 6C.

Preferably, the wetting properties are such that the carrier fluid wets the solid walls, thus forming a film around the microdrop(s) including the sol. In this case, the microdrops formed in the capillary traps are substantially identical.

As a variant, not shown, the trapping of the microdrops 15 takes place by formation of the microdrops including the sol upstream of the capillary traps 12 and by trapping the already-formed microdrops 15. The formation of the microdrops may take place directly in the microfluidic device in a mobile phase between the inlet channel 30 and the outlet channel 34.

Numerous processes have already been proposed for forming such first microdrops in a mobile phase. Mention may be made, for example, of the following process examples:
a) the “flow-focusing” process described, for example, in S. L. Anna, N. Bontoux and H. A. Stone, “Formation of dispersions using ‘flow-focusing’ in microchannels”, Appl. Phys. Lett. 82, 364 (2003), the content of which is incorporated herein by reference,
b) the “step emulsification” process described, for example, by R. Seemann, M. Brinkmann, T. Pfohl and S. Herminghaus, in “Droplet-based microfluidics.,” Rep. Prog. Phys., volume 75, number. 1, page 016601, January 2012, the content of which is incorporated herein by reference,
c) a process combining the “flow-focusing” and “step emulsification” processes, described, for example, by V. Chokkalingam, S. Herminghaus and R. Seemann in “Self-synchronizing pairwise production of monodisperse droplets by microfluidic step emulsification”, Appl. Phys. Lett., volume 93, number. 25, page 254101, 2008, the content of which is incorporated herein by reference,
d) the “T-junction” process described, for example, by G. F. Christopher and S. L. Anna in “Microfluidic methods for generating continuous droplet streams”, J. Phys. D. Appl. Phys., volume 40, number 19, pages R319-R336, October 2007, the content of which is incorporated herein by reference,
e) the “confinement gradient” process described, for example, by R. Dangla, S. C. Kayi, and C. N. Baroud in “Droplet microfluidics driven by gradients of confinement.,” Proc. Natl. Acad. Sci. U.S.A., volume 110, number 3, pages. 853-8, January 2013, the content of which is incorporated herein by reference, or
f) the “micro-segmented flows” process described, for example, by A. Funfak, R. Hartung, J. Cao, K. Martin, K. H. Wiesmuller, O. S. Wolfbeis and J. M. Köhler in “Highly resolved dose-response functions for drug-modulated bacteria cultivation obtained by fluorometric and photometric flow-through sensing in microsegmented flow”, Sensors Actuators, B Chem., volume 142, number 1, pages 66-72, 2009, the content of which is incorporated herein by reference, in which two solutions in different proportions and controlled are mixed at the level of a function outside the microfluidic system to form microliter drops separated by an immiscible phase, followed by a process of division of these drops into microdrops by injecting them, for example, into a microfluidic system containing a gradient.

These processes notably make it possible to form a plurality of microdrops of substantially equal dimensions. The dimensions of the microdrops obtained may be controlled by modifying the microdrop formation parameters, notably the flow rate of the fluids in the device and/or the shape of the device.

The microdrops 15 may be produced on the same microfluidic system as the process or on a different device. In the latter case, the microdrops 15 may be stored in one or more external containers before being injected into the microfluidic system. These microdrops 15 may all be identical or some of them may have different compositions, concentrations and/or sizes.

After formation of these microdrops 15, they may be conveyed to the capillary trap 12 by entrainment with a stream of a fluid and/or by means of gradients or of reliefs in the form of rails. In both cases, the addition of rails may make it possible to optimize the filling of the capillary traps 12, selectively, for example by combination with the use of an infrared laser, as is described by E. Fradet, C. McDougall, P. Abbyad, R. Dangla, D. McGloin and C. N. Baroud in “Combining rails and anchors with laser forcing for selective manipulation within 2D droplet arrays.,” Lab Chip, volume 11, number 24, pages 4228-34, December 2011.

If the microdrop production is performed outside the microfluidic device, their transportation from the storage to the microfluidic device 1 may take place directly via a tube connecting, for example, the production system and the trapping system or by suction and injection with a syringe.

The microdrops 15 trapped in the capillary traps then include a sol which forms the sol-gel matrix via a sol-gel process. In the processes described previously, the sol-gel process starts before the trapping of the microdrops 15, as soon as the sol is formed. It is then preferable for the gel time to be less than the time required between the preparation of the sol and the trapping of the microdrops 15 so as to avoid formation of the sol-gel matrix outside the capillary traps 12, which would block the microdrop(s) concerned outside the capillary traps.

As a variant, the microdrops 15 including a sol which are trapped in the capillary traps 12 may be formed in several steps by coalescence of several microdrops in each capillary trap 12. The microdrops allowing the formation of the microdrop including the sol may be added in one or more steps. Making the sol in several steps in the microdrop by addition of complementary microdrops makes it possible to multiply the possibilities. It is possible to have first microdrops that are all identical in the capillary traps and to add thereto complementary microdrops of different compositions and/or in different amounts to the different capillary traps. This also allows the formation of the sol-gel matrix solely in the capillary traps 12, the sol-gel process not taking place as long as the sol is not complete. For example, microdrops of a first solution including a portion of the sol can be trapped in the capillary traps 12 via one of the methods described previously, and complementary microdrops including the other portion of the sol, for example water, can then be added and trapped in each capillary trap 12 to form, by coalescence, the microdrops 15 including the sol.

The coalescence may or may not be selective.

To fuse all of the microdrops in contact in a trapping chamber 20, the device may be perfused with a surfactant-free fluid. The surfactant concentration in the fluid of the microfluidic system decreases, enabling the equilibrium of surfactant adsorption at the interface to be shifted toward desorption. The microdrops lose their stabilizing effect and fuse spontaneously with the microdrops with which they are in contact.

As a variant, the microfluidic device is perfused with a fluid containing a destabilizer. The destabilizer is, for example, 1H,1H,2H,2H-perfluorooctan-1-ol in a fluoro oil in the case of aqueous microdrops.

As another variant, all of the microdrops in contact in a trapping chamber 20 are fused by providing an external physical stimulus, such as mechanical waves, pressure waves, a temperature change or an electric field.

An infrared laser may be used to selectively fuse the microdrops, as is described by E. Fradet, P. Abbyad, M. H. Vos and C. N. Baroud in “Parallel measurements of reaction kinetics using ultralow-volumes,” Lab Chip, volume 13, number 22, pages 4326-30, October 2013, or electrodes 37 located at the interfaces of microdrops between the trapping zones may be activated, as is illustrated in FIG. 51, or mechanical waves may be focused at one or more points.

The invention is not limited to the coalescence examples described above. Any method for destabilizing the interface between two microdrops in contact may be used for fusing the microdrops.

It is then possible to take a measurement of the state of the microdrops obtained and/or to perform real-time observation of said microdrops. This enables, for example, study of the sol-gel process.

The above trapping processes allow the trapping of identical and/or different microdrops 15 in the capillary traps, notably microdrops having different sol compositions or different concentrations of sol compounds.

During this sol-gel process, each sol-gel matrix passes through a step of shrinkage of the sol-gel matrix with expulsion of the solvent, in other words syneresis, and evaporation of the solvent, also referred to as drying of the matrix, to form the microbeads including the sol-gel matrix as illustrated in FIG. 7. In the microfluidic device as described previously, the microdrops 15 are encapsulated in the microfluidic device. In this case, the solvent can evaporate through a wall of the device when said wall is gas-porous, notably through the wall made of PDMS or by circulation of a gas in the microfluidic device between the inlet channel 30 and the outlet channel 34. The evaporation of the solvent during the syneresis step may be controlled by controlling the pore size of the porous wall and/or by controlling the flow rate of the gas in the microfluidic device.

Preferably, the microfluidic device 1 includes a system, not shown, for controlling the temperature in the trapping chamber 20, making it possible notably to control the formation of the sol-gel matrix. The control system makes it possible notably to lower the temperature of the microfluidic device 1 during the trapping of the microdrops 15, so as to slow down the formation of gel and to prevent said gel from forming before the trapping of the microdrops 15 and/or to increase the temperature of the microfluidic device during the formation of the sol-gel matrix so as to accelerate it. Preferably, the temperature of the microfluidic device during the trapping is between 0 and 30° C., better still between 5 and 15° C. and the temperature of the microfluidic device during the formation of the sol-gel matrix is between 20 and 80° C., better still between 20 and 60° C. and even better still between 30 and 50° C.

In the examples described above, the microdrops 15 may also include one or more molecular sensors integrated into the sol-gel matrix, which have an optical property, notably in terms of color or fluorescence, which changes on contact with a particular target analyte. The change in optical property may take place by reaction or bonding with the target analyte and enables rapid detection, by simple observation of the microdrops 15 located in the capillary traps 12, of the presence or absence, in a fluid in contact with the microdrops, of the corresponding target analyte(s). In the case where the molecular sensor(s) form a bond with the corresponding target analyte, it is also possible to collect the analyte by recovering the microdrops in the capillary trap(s).

The molecular sensor(s) may include detection molecules chosen from 4-amino-3-penten-2-one, p-dimethylaminobenzaldehyde, p-dimethylaminocinnamaldehyde, p-methoxybenzaldehyde, 4-methoxynaphthaldehyde, crotonic acid, p-diazobenzenesulfonic acid, 4-aminoantipyrine, carmine indigo, a quinone compound, a mixture of iodide and of a compound chosen from starch, amylose, amylopectin, xyloglucan, xylan, chitosan, glycogen, polyvinyl alcohol or a polyvinyl alcohol compound, cellulose or a cellulose compound, α-cyclodextrin, theobromine and block polymers of polypropylene oxide and polyethylene oxide, a sensor including a phenol and sodium nitroprusside, and the compound as described in patent application WO 2005/100371 which is incorporated herein by reference. Additives such as solvents, oxidizing agents, reducing agents, acids or bases may be added so as to promote the reactions with the target analytes. This list is not exhaustive: any molecule allowing, alone or in combination with others, a more or less selective interaction with a target analyte or chemical function may be added to the molecular sensor, notably polymers, complexing agents, colored pH indicators, dyes, fluorophores, phthalocyanins and porphyrins.

The molecular sensor(s) may each make it possible to detect a target analyte chosen from volatile organic compounds, notably those defined in the lists of priority pollutants from ANSES (Agence Nationale de Sécurité Sanitaire de l'alimentation de l'environnement et du travail), notably aldehydes, such as formaldehyde, acetaldehyde and hexaldehyde, carbon monoxide or carbon dioxide, dioxygen, hydrogen, phenol and derivatives thereof, indole compounds, notably indole, scatole or tryptophan, chloramines, nitrogen dioxide, ozone, halogenated compounds, notably boron trifluoride, derivatives thereof and boron trichloride, aromatic hydrocarbons, such as naphthalene, benzene and toluene and nonaromatic hydrocarbons, such as pentane, hexane and heptane, acrolein, nitrogen dioxide and ethylbenzene.

The concentration of the detection molecule of which the molecular sensor is composed in a sol microdrop may be adapted so as to have the highest possible concentration while at the same time remaining soluble in the microdrop and in the final form dedicated to the analysis, notably the gel or the solid material. The optimum concentration depends on the molecules of which the molecular sensor is constituted and the sol-gel formulation. For example, the concentration of 4-amino-3-penten-2-one for detecting formaldehyde with a sol formulation containing zirconium butoxide, acetylacetate, butanol, TEOS and water in respective molar proportions of (1:1:16:1:22) is, in the sol which is the precursor of a microdrop 15, preferably between 0.05 and 0.4 M, better still between 0.2 to 0.3 M in the sol.

The microdrops 15 may all include the same molecular sensor in the same concentration or may include different molecular sensors or molecular sensors in different concentrations.

As a variant, the microdrops 15 may each include several molecular sensors having different responses to the target analytes, for example different colors.

The molecular sensor(s) may be inserted directly into the sol during the formation of the sol prior to the trapping or directly into the first solution including a portion of the sol.

As a variant, the molecular sensor(s) may be inserted in the form of additional microdrops into the capillary traps 12 and then fused with the microdrops including a portion of the sol or including the sol before formation of the gel or the gel undergoing formation. The additional microdrops may be identical or different, and may notably include one or more different molecular sensors and/or molecular sensors in different concentrations and/or the number of additional microdrops trapped in each capillary trap may be identical or different.

It is possible to control the addition of the complementary or additional microdrops by the form of the microdrops and the process for adding the additional or complementary microdrops, as is described in patent application FR 3 056 927 incorporated by reference.

It is then clearly seen that the various processes described previously, combined with the form of the microfluidic device 1, notably of the capillary traps 12, and with the composition and form of the microdrops makes it possible to obtain a wide diversity of devices for performing studies or statistical measurements and/or multiplexing.

The concentration at which the analytes must be detected is generally associated either with precise specifications, notably a particular industrial process, or in response to a regulation. The composition of the microdrop and the formation of the sol-gel matrix depend on the concentration that must be detected according to the specifications and/or the regulation. For example, the current regulation regarding formaldehyde in France stipulates action at and above a threshold of 100 μg/m³ of formaldehyde. The microdrops 15 including a sol-gel matrix formed in the examples preferably enable the detection of formaldehyde at a concentration of between 10 and 500 μg/m³.

The device may also make it possible to determine the analyte concentration in the fluid to be tested or a concentration gradient of analyte in the fluid to be tested notably by visualization of the intensity of detection of each microdrop 15 including a sol-gel matrix according to its position on the microfluidic device.

During the step of detecting the target analytes, the fluid to be tested is preferably introduced into the device, notably by means of a fluid circulation system not shown, via the inlet channel 30 and is circulated in the device to come into contact with the microdrops 15.

As a variant, when the fluid to be tested is gaseous, it is placed in contact with the microdrops 15 by diffusion through a porous wall, notably made of PDMS, of the microfluidic device. The device then merely has to be placed in the environment containing the gas to be tested.

As a further variant, the fluid to be tested is inserted into the device in liquid form to form a liquid front delimited by the step 40 as described previously, and the microdrops 15 are then placed in contact with the vapors coming from the liquid diffusing in the microfluidic device.

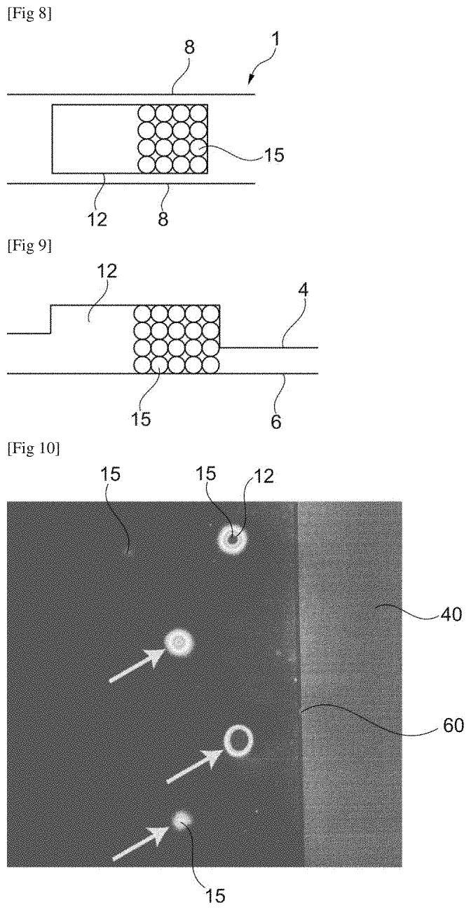

FIGS. 8 and 9 schematically depict a third embodiment of a microfluidic device 1 according to the invention which differs from the preceding devices in that the device includes a capillary trap 12 which traps a plurality of microdrops 15 including a sol-gel matrix. In this device, the microdrops 12 are preferably formed before being trapped. In the example illustrated, the capillary trap 12 is formed of a cavity in the upper wall 4 and the microdrops 15 including a sol-gel matrix form a column of microdrops in the capillary trap 12. Preferably, in such a device including several microdrops per capillary trap 12, the microdrops 15 include a surfactant for preventing the mutual coalescence of the drops.

In this embodiment, the microdrops 15 including the sol are formed prior to being trapped in the capillary trap 12.

### Example 1

To obtain a zirconium butoxide solution, a first mixture is prepared at room temperature (20° C.) with zirconium butoxide and acetylacetate in equal proportions, in butanol as solvent. In a preferential mode, the respective molar proportions are (1:1:16). The mixture is left to stand overnight, TEOS and water are then added thereto so as to obtain final respective molar proportions of (1:1:16:1:22), followed by vigorous stirring. The sol solution obtained is then rapidly introduced into the microfluidic device according to the second embodiment described above, at 20° C., prefilled with fluoro oil. The sol solution is distributed among the capillary traps by the breaking method described previously. The microsystem is then heated, for example to 40° C., to accelerate the formation of the gel in the microdrops 15, the syneresis and the evaporation of the solvent through a PDMS wall of the microfluidic device.

A microfluidic device according to FIG. 7 is then obtained.

### Example 2

A microfluidic device is prepared as in example 1, except that 4-amino-3-penten-2-one is dissolved in the zirconium butoxide solution before adding the TEOS and water. 4-Amino-3-penten-2-one is a detection unit for detecting formaldehyde. In the presence of the latter, it goes from colorless to dark yellow, emitting yellow-colored fluorescence.

The microdrops 15 are indeed formed.

### Example 3

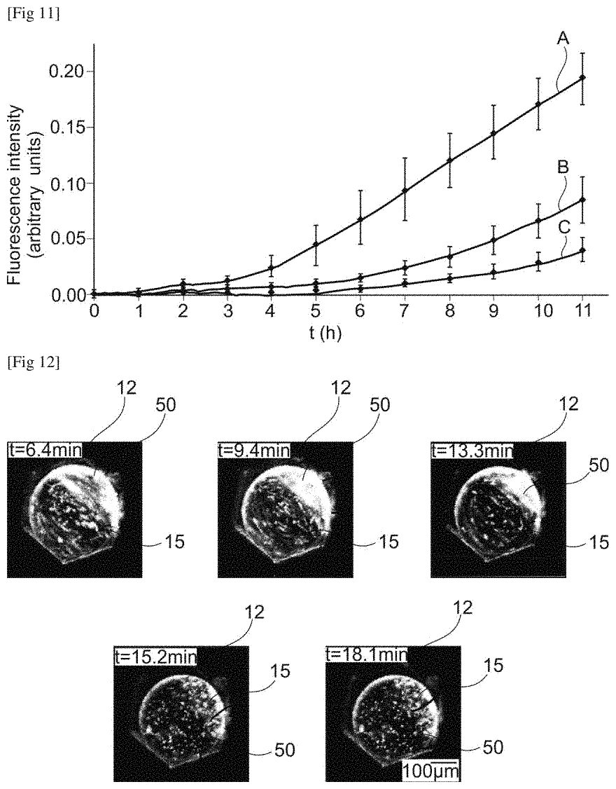

A microfluidic device prepared as in example 2 is continuously exposed to gaseous formaldehyde by positioning a front of a liquid formaldehyde solution 60 according to the method described previously. The fluorescence of the microdrops 15 is observed over time. A photo at a given time of a portion of the device close to the liquid front 60 is shown in FIG. 10. It is seen in this figure that the fluorescence of the microdrops 15 close to the liquid front is greater than that of the microdrops 15 that are further away. The microdrops 15 in the device are separated into three groups as a function of their distance from the liquid front and a statistical measurement of the fluorescence as a function of the group is taken as a function of time in FIG. 11, group A being the closest to the liquid front 60 and group C being the furthest from the liquid front 60. The microdrops 15 of group A represented by curve A are the most fluorescent and the microdrops 15 of group C represented by curve C are the least fluorescent. Fluorescence monitoring of the microdrops 15 demonstrates the reaction between the gaseous formaldehyde and the 4-amino-3-penten-2-one in the microdrops. The gradual increase in intensity over time as a function of the distance from the front demonstrates the possibility of measuring the concentration of gaseous formaldehyde in a fluid. Thus, the microdrops 15 detect the presence of formaldehyde and respond correctly as a function of its concentration. Furthermore, they are capable of recording slight local variations. Regrouping of the microdrops in a column clearly shows that this microsystem makes it possible to measure the concentration statistically with a single microsystem.

### Example 4

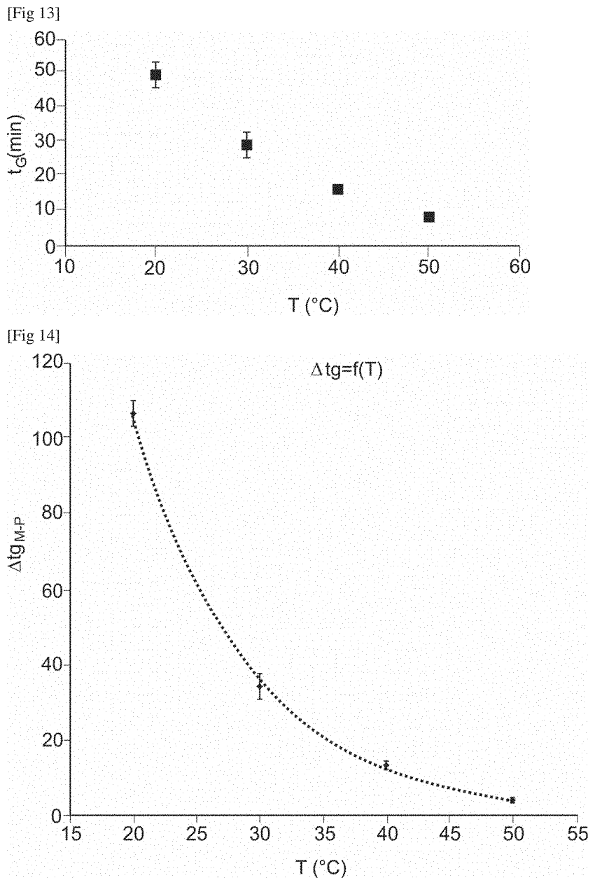

Fluorescent microbeads 50 are added to the sol of the microfluidic device prepared according to example 1, followed by injection into the microfluidic system. The sol microdrops 15 imprisoned in the capillary traps 12 are subjected to an oil stream, which gives rise to movement of the microbeads in the sol. The movement of the beads stops when the gel sets, as may be seen in FIG. 12 in which the fluorescent microbeads 50 are observed at different times in a microdrop 15, enabling determination of the gel time corresponding to the time between the formation of the sol and the setting of the gel. This observation was made at different temperatures as illustrated in FIG. 13 showing the gel time t_{G} measured statistically in the microfluidic device as a function of the temperature T. The temperature in the microfluidic device is controlled by a Peltier-effect module on which the microfluidic device is posed and the estimation of the gel time is made on several microdrops, notably 20 microdrops, so as to obtain a statistical measurement.

The gel times measured in the microfluidic device are much shorter than those conventionally measured in tubes. FIG. 14 shows a curve representing the mathematical relationship which makes it possible to go from one to another for the sol-gel matrix studied.

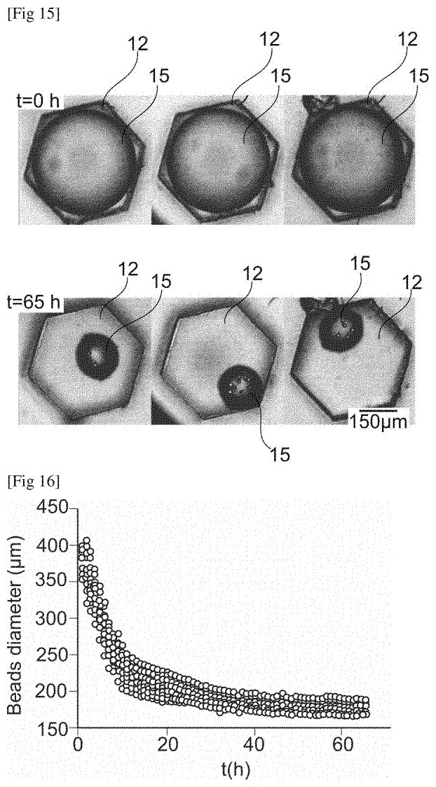

It is also possible to observe the syneresis over time, as is shown in FIG. 15 representing three microdrops 15 at t=0 and at t=65 hours after syneresis. It is then possible to statistically measure the size of the microdrops 16 over time, as illustrated in FIG. 15. The curve is obtained by taking a sequence of images at different times of ten microdrops in ten different traps and by measuring the size of the microdrops in each image. The size of the microdrops 15 goes from about 380 μm to 175 μm, which is a shrinkage of more than 50%. This notably makes it possible to optimize the sol-gel process for preparing microfluidic devices for the detection of analytes.

### Example 5

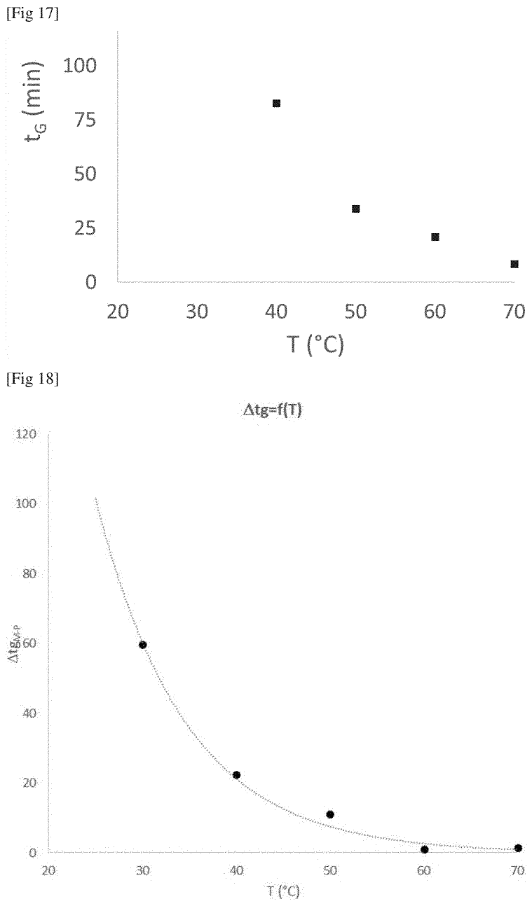

The curves in FIGS. 17 and 18 are obtained with the same procedure as those of example 4, but with a different sol, and over a wider temperature range. To obtain a tetramethyl orthosilicate (TMOS) solution, a first mixture is prepared at room temperature (20° C.) with (TMOS) and water, in methanol as solvent. The molar proportions of TMOS, methanol and water are, respectively, (1:2:4). The mixture is heated at 70° C. for 10 minutes, and water is then added thereto so as to obtain final respective molar proportions of (1:2:9), followed by vigorous stirring. Fluorescent microbeads 50 are added to the sol of the microfluidic device prepared, followed by injection into the microfluidic system prefilled with fluoro oil. The sol solution is distributed among the capillary traps by the breaking method described previously. The microsystem is then heated to a given temperature T.

The gel time is determined by observing the movement of the beads. This observation was made at different temperatures as illustrated in FIG. 17 showing the gel time t_{G} measured statistically in the microfluidic device as a function of the temperature T. The sol as defined in this example may be used in the microfluidic device up to 70° C.

FIG. 18 shows a curve representing the mathematical relationship which makes it possible to go from the microfluidic device according to the invention to a conventional tube for the sol-gel matrix studied.

As is clearly seen in examples 4 and 5, it is then possible to predict the gel times for a sol-gel process on a macroscopic scale by means of studying the microdrops using the same sol-gel process. This makes it possible very rapidly to measure different gel times in a microfluidic device according to the invention without the need to perform macroscopic experiments and consequently to save time, automate the measurement and consume less reagents.

1. A microfluidic device including:
at least one capillary trap, and
at least one microdrop including a sol-gel matrix, the microdrop being trapped in the capillary trap.

2. The device as claimed in claim 1, including a plurality of spaced-apart capillary traps and a plurality of microdrops each including a sol-gel matrix, the microdrops each being trapped in one of the capillary traps.

3. The device as claimed in claim 2, in which the number of capillary traps is greater than or equal to 10.

4. The device as claimed in claim 1, in which the capillary trap(s) each form a cavity in a wall of the microfluidic device.

5. The device as claimed in claim 4, for which the height H at the edge of the capillary trap(s), corresponding to the distance between the wall in which the cavity is formed and the opposite wall at the edge of the capillary trap, is less than or equal to the smallest dimension of the or of each trapped microdrop including a sol-gel matrix.

6. The device as claimed in claim 1, in which the sol-gel matrix of the or of each microdrop is in gel or solid form after the syneresis and/or drying step of the sol-gel process.

7. The device as claimed in claim 1, in which the device includes only one microdrop including a sol-gel matrix in the or each capillary trap.

8. The device as claimed in claim 1, including a plurality of microdrops including a sol-gel matrix in the or each capillary trap, the microdrops including a sol-gel matrix.

9. The device as claimed in claim 1, in which the device includes a plurality of microdrops all including a substantially identical sol-gel matrix.

10. The device as claimed in claim 1, in which the microdrop(s) each include one or more molecular sensors in the sol-gel matrix, which are each configured to detect for the presence of a target analyte.

11. The device as claimed in claim 10, in which the or each molecular sensor is configured to have an optical property which is different in the presence of the target analyte.

12. The device as claimed in claim 10, in which the microdrop(s) include at least two different molecular sensors for detecting different target analytes.

13. The device as claimed in claim 10, in which at least one microdrop includes at least two different molecular sensors in the sol-gel matrix, which are configured to detect for the presence of different target analytes.

14. The device as claimed in claim 10, in which at least two microdrops include different molecular sensors for detecting different target analytes.

15. The device as claimed in claim 10, in which at least two microdrops include different concentrations of at least one molecular sensor.

16. A process for manufacturing a microfluidic device, the process including the trapping of at least one microdrop including a sol in a capillary trap of the microfluidic device and the formation of a sol-gel matrix in the microdrop using the sol via a sol-gel process.

17. The process as claimed in claim 16, including the trapping of a plurality of microdrops including a sol in one or more capillary traps of the microfluidic device and the formation of a sol-gel matrix in each microdrop using the sol via a sol-gel process.

18. The process as claimed in claim 16, including the addition of one or more molecular sensors to the microdrop(s) before or after formation of the sol-gel matrix, each molecular sensor enabling the detection of at least one target analyte.

19. The process as claimed in claim 16, in which the trapping of one or more microdrops each including a sol in the capillary trap(s) includes:
(i) the trapping of a first microdrop including a portion of the sol in the or each capillary trap,
(ii) n successive additions of one or more complementary microdrops including another portion of the sol to the microfluidic device to trap it (them) in the or each capillary trap, n being an integer, and the coalescence of the first microdrop and of the complementary microdrop(s) in each capillary trap to obtain the microdrop including the sol, the coalescence taking place after each successive addition or after all of the successive additions,
(iii) optionally the addition of additional microdrops including one or more molecular sensors to the microfluidic device, the trapping of said additional microdrop(s) in the capillary trap(s) and the coalescence of the additional microdrops and of the microdrop in the or each capillary trap, step (iii) taking place before or after step (ii).

20. The process as claimed in claim 16, including a prior step of forming the microdrop(s) including the sol or the first microdrop(s) including a portion of the sol before the step of trapping in the capillary traps.

21. The process as claimed in claim 16, in which the trapping of the microdrop(s) including the sol or of the first microdrop(s) including a portion of the sol includes:
the filling of the microfluidic device with a first solution including the sol or the sol portion and optionally one or more molecular sensors in the sol,
the injection of a second solution upstream of the capillary trap(s) to push the first solution toward an outlet of the microfluidic device downstream of the capillary trap(s), the microfluidic device being configured to enable the formation of a microdrop of the first solution in the or each capillary trap during the injection of the second solution into the microfluidic device.

22. The process as claimed in claim 16, in which the gel time of the sol is greater than or equal to 5 minutes.

23. The process as claimed in claim 16, including control of the temperature of the microfluidic device during the process.

24. The process as claimed in claim 16, including syneresis, and drying step by evaporation of the solvent contained in the sol-gel matrix through a gas-porous surface of the microfluidic device or by circulation of a fluid in the microfluidic device between at least one inlet channel upstream of the capillary traps and at least one outlet channel downstream of the capillary traps.

25. A process for detecting and/or trapping one or more analytes in a fluid to be tested using the microfluidic device as claimed in claim 1, the microdrop(s) trapped in the capillary trap(s) each including in the sol-gel matrix one or more molecular sensors configured to detect and/or trap one or more target analytes, the process including the exposure of the microdrop(s) trapped in the microfluidic device to a fluid to be tested and the detection and/or trapping of the target analyte(s) in the fluid to be tested.

26. The process as claimed in claim 25, in which the fluid is a gas and the exposure of the microdrop(s) takes place through a gas-porous wall of the microfluidic device or by circulation of the gas in the microfluidic device from an inlet channel of the microfluidic device upstream of the capillary trap(s) to an outlet channel of the microfluidic device downstream of the capillary trap(s) by means of a microfluidic system.

27. The process as claimed in claim 25, including the introduction of a liquid into the microfluidic device until a liquid front forms in the vicinity of the microdrop(s) the microdrop(s) not being in contact with the liquid, the microdrops being exposed to a gas formed by evaporation of the liquid in the microfluidic device from the liquid front.

28. The process as claimed in claim 25, including the determination of the concentration, to which is exposed the or each microdrop of the microfluidic device, of at least one target analyte in the fluid to be tested.

29. A process for evaluating a sol-gel matrix in a microfluidic device as claimed in claim 1, the microdrop(s) trapped in the capillary traps including said sol-gel matrix.

30. The process as claimed in claim 29, including evaluation of the gel time of the sol during the formation of the sol-gel matrix in the microdrop.
